(19) United States
(12) Patent Application Publication
(10) Pub. No.: US 2026/0295450 A1
(43) Pub. Date: Oct. 1, 2026

(54) BUILDING PLATE FOR A TOY BUILDING SET

(71) Applicant: LEGO A/S, Billund (DK)

(72) Inventor: Jørgen SØGÅRD, Billund (DK)

(73) Assignee: LEGO A/S, Billund (DK)

(21) Appl. No.: 19/146,312

(22) PCT Filed: Dec. 28, 2023
(86) PCT No.: PCT/EP2023/087879

§ 371 Date: Jul. 8, 2025

(30) Foreign Application Priority Data
Jan. 13, 2023 (DK) PA202370013

(51) Int. Cl. A63H 33/04; A63H 33/08; H05B 45/20; H05B 47/105

(52) U.S. Cl. CPC A63H 33/042; A63H 33/086; H05B 45/20; H05B 47/105

(57) ABSTRACT

A toy building set is disclosed, featuring a baseplate with a grid of coupling knobs. A light-emitting device positioned beneath the baseplate selectively illuminates these knobs. The set further includes a position detection scanner comprising a light emitter for illuminating a grid of light beams near the coupling knobs, and a light receiver for sensing the presence or interruption of these beams. A controller receives signals from the position detection scanner and, based on these signals, controls the illumination of the coupling knobs by the light-emitting device.

### CROSS-REFERENCE TO RELATED APPLICATIONS

The present disclosure is a U.S. National Stage Application under 35 U.S.C. 371 of co-pending International Application No. PCT/EP2023/087879 filed on Dec. 28, 2023, which claims the benefit of Danish Patent Application No. PA202370013, filed on Jan. 13, 2023, the contents of each of which are incorporated by reference herein in tehri entirety for all purposes.

### FIELD OF THE DISCLOSURE

The present disclosure relates to toy building plates and especially to an interactive toy building plate comprising a baseplate having an upper surface area provided with multiple coupling knobs arranged in a repetitive pattern and where at least the multiple coupling knobs comprises a translucent or transparent material so that light can pass from below the baseplate and illuminate the coupling knobs, and a controller and a light emitting device is arranged below the baseplate and being adapted for selectively illuminating single or groups of the multiple coupling knobs.

### BACKGROUND

U.S. Pat. No. 9,168,464 discloses such a building plate having a transparent baseplate with coupling knobs. According to this prior art a touch sensitive membrane and an image generating device is arranged underneath the transparent baseplate so that the coupling knobs can be pressed against the touch sensitive membrane and thereby cause the image generated by the image generating device to change.

### SUMMARY

On this background it is the object of the present disclosure to provide such a building plate being relatively simple and sturdy in construction and at the same time providing the possibility of designing the appearance of the building plate.

According to the disclosure this is obtained by the building plate as defined in claim 1 where the building plate further comprises a position detection scanner with light emitters adapted for forming a grid of light beams extending above the coupling knobs and light receivers adapted for sensing the presence or interruption of light emitted from the light emitters, and where the controller is adapted for receiving signals from the position detection scanner and to control the light emitting device in dependence of the signals received from the position detection scanner.

In this relation the position scanner that forms a grid of light beams extending above the coupling knobs provides that the baseplate may be made at least as sturdy as existing conventional non-interactive baseplates for toy construction and thereby also provide an increased protection of the light emitting device.

In a preferred embodiment the coupling knobs are arranged in a square pattern all having the same modular distance between two closest neighboring coupling knobs.

The position detection scanner may in this relation comprise a square or rectangular frame extending along the periphery of the baseplate.

It will be apparent to the skilled person that any type of non-tactile position detection scanner, such as the position detection sensor disclosed in U.S. Pat. No. 7,903,097 which is hereby incorporated by reference and that may be suitable for this purpose as long as it is able to detect the position an object, e.g. the tip of a user's finger, touching any one of the coupling knobs and thereby interrupts one or more light beams extending above the coupling knobs. In a preferred embodiment, however, the light emitters and receivers are advantageously arranged in the frame so that at least two light beams are crossing each other over each of the multiple coupling knobs.

In this relation the controller may preferably be adapted to turn on the illumination of a selected coupling knob when the position detection scanner detects interruption of two light beams crossing over the selected coupling knob.

In an especially simple embodiment, the light emitting device comprises an array of LEDs arranged below the baseplate, and the array of LEDs comprises a single LED or a group of LEDs arranged beneath each one of the coupling knobs comprising the translucent or transparent material.

The controller and the light emitting device are preferably adapted to control the color of the light emitted through each of the multiple coupling knobs.

Advantageously the baseplate comprises a second area forming a user interface allowing the user to program the controller.

In this relation, the light beams from the position detection scanner may advantageously also extend above the second area and where the controller being adapted to control the color of and/or to switch on or off the illumination of a selected coupling knob in dependence of where the position detection scanner detects interruption of two light beams crossing over the second area.

The position detection scanner, the baseplate and the light emitting device may be formed as a single assembly/unit.

The present disclosure also relates to a toy construction set comprising a building plate as mentioned above as well as a number of building blocks each having complementary coupling sockets adapted for mounting each building block on the coupling knobs.

### BRIEF DESCRIPTION OF THE DRAWINGS

FIG. 1: Is a principle drawing showing one embodiment of the building plate according to the disclosure in an exploded view.

FIG. 2: Is a principle drawing showing the assembled building plate shown in FIG. 1.

### DETAILED DESCRIPTION

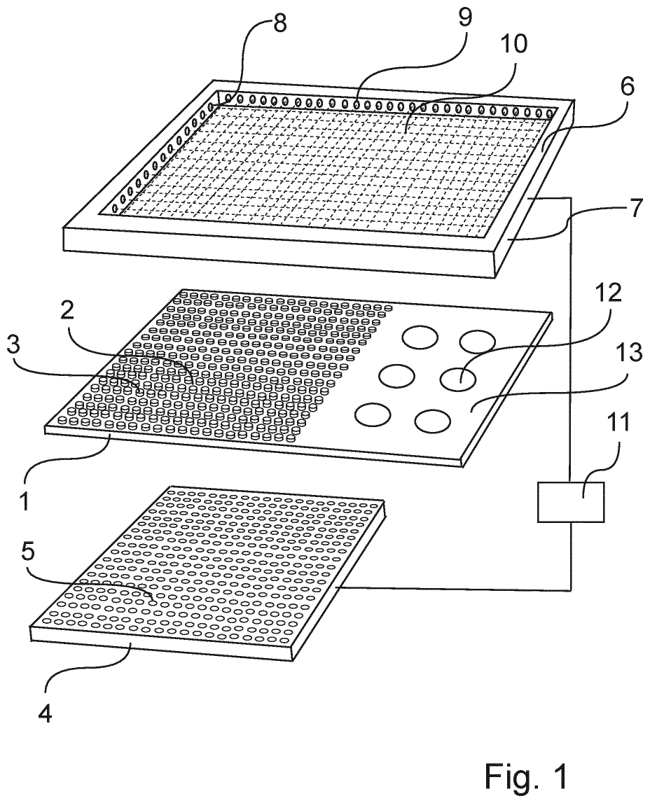

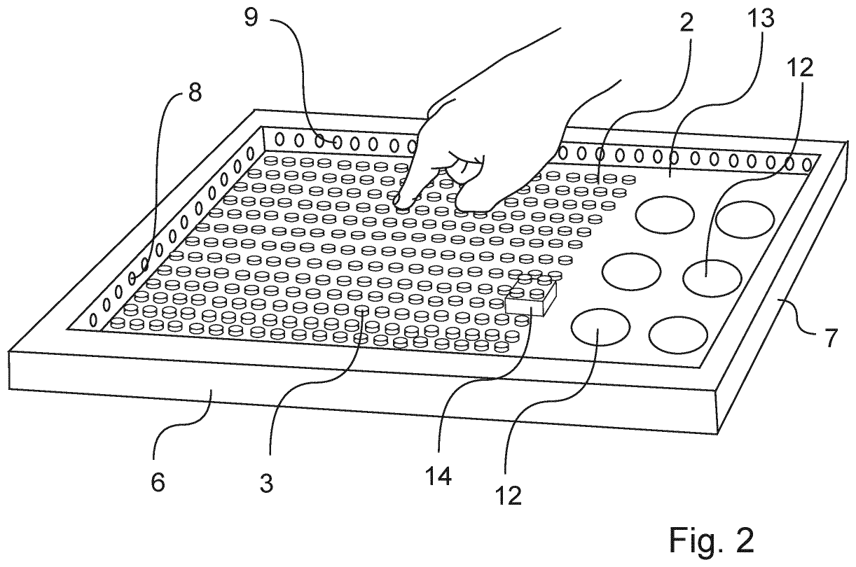

FIGS. 1 and 2 shows one embodiment of the disclosure where FIG. 1 shows an exploded view of the components of the building plate according to the disclosure and FIG. 2 shows the assembled building plate.

According to this embodiment the building plate comprises a baseplate 1 having an upper surface area 2 provided with multiple coupling knobs 3 adapted for mounting e.g. toy building blocks. In this embodiment the baseplate is made from a translucent or transparent plastic material. The baseplate also comprises a second area 13 forming a user interface with a number of touch fields allowing the user to program the controller 11

A light emitting device 4 is arranged below the baseplate and the light emitting device 4 comprises multiple LEDs 5 each being controllable independently of the other LEDs 5 and each being able to emit light in multiple colors such as e.g. RGB LEDs. Thereby the light emitting device 4 can be controlled by the controller 11 to display an image.

In this embodiment the number and mutual distance of the LEDs 5 correspond to the number and mutual distance of the coupling knobs 2 on the baseplate 1, so that the LEDs 5 can efficiently illuminate each individual coupling knob 2 so that the image displayed by the LEDs 5 is transmitted to the baseplate 1.

The building plate further comprises a position detection scanner 6 with a frame 7 or bezel extending along the periphery of the baseplate 1. Multiple light emitters 8 and light receivers 9 are arranged on the inside of the frame 7 so that they form a grid of light beams 10 extending above the coupling knobs 3 on the baseplate 1. Thereby the position detection scanner 6 can detect the position of any interruption of the light beams and transmit this information to the controller 11.

The controller 11 is adapted so that it can turn any LED 5 on or off and to switch the color of any of the LEDs when an interruption of the light beams 10 extending over a selected coupling knob 3 or touch field 12 on the baseplate 1 is detected, and thereby a user can change the image on the baseplate via the user interface by e.g. changing the color of each LED 5 independently.

FIG. 2 shows the use of the building plate where the user can easily touch any one of the coupling knobs 3 or any one of the touch fields 12 some of the light beams are interrupted so that the position detection scanner 6 detects the position of the interruption and can transfer this information to the controller 11 so that it changes the image on the light emitting device in accordance with the users input. The interruption may also be provided by mounting one or more building blocks 14 on the coupling knobs 3 such as shown in FIG. 2. Thereby the building blocks 14 forming part of a toy building set may also be used to program the controller.

1. A building plate for a toy building set, the building plate comprising: a baseplate having an upper surface area provided with multiple coupling knobs arranged in a repetitive pattern and where at least the multiple coupling knobs comprises a translucent or transparent material so that light can pass from below the baseplate and illuminate the coupling knobs, and where a controller and a light emitting device is arranged below the baseplate and being adapted for selectively illuminating single or groups of the multiple coupling knobs, and wherein the building plate further comprises a position detection scanner with light emitters adapted for forming a grid of light beams extending above the coupling knobs and light receivers adapted for sensing the presence or interruption of light emitted from the light emitters, and where the controller is adapted for receiving signals from the position detection scanner and to control the light emitting device in dependence of the signals received from the position detection scanner.

2. The building plate according to claim 1, wherein the coupling knobs are arranged in a square pattern all having the same modular distance between two closest neighboring coupling knobs.

3. The building plate according to claim 2, wherein the position detection scanner comprises a square or rectangular frame extending along the periphery of the baseplate.

4. The building plate according to claim 2, wherein the light emitters and receivers are arranged in the frame so that at least two light beams are crossing each other over each of the multiple coupling knobs.

5. The building plate according to claim 4, wherein the controller is configured to turn on the illumination of a selected coupling knob when the position detection scanner detects interruption of two light beams crossing over the selected coupling knob.

6. The building plate according to claim 1, wherein the light emitting device comprises an array of LEDs arranged below the baseplate, and where the array of LEDs comprises a single LED or a group of LEDs arranged beneath each one of the coupling knobs comprising the translucent or transparent material.

7. The building plate according to claim 1, wherein the controller and the light emitting device is adapted to control the color of the light emitted through each of the multiple coupling knobs.

8. The building plate according to claim 7, wherein the baseplate comprises a second area forming a user interface allowing the user to program the controller.

9. The building plate according to claim 8, wherein the light beams from the position detection scanner also extend above the second area and where the controller is adapted to control the color of and/or to switch on or off the illumination of a selected coupling knob in dependence of where the position detection scanner detects interruption of two light beams crossing over the second area.

10. The building plate according to claim 1, wherein the baseplate, the position detection scanner and the light emitting device forms a single unit.

11. The toy construction set comprising a building plate according to claim 1, and a number of building blocks each having complementary coupling sockets adapted for mounting each building block on the coupling knobs.

12. A toy building set, comprising:
a baseplate defining a plurality of coupling knobs arranged in a grid formation on the baseplate;
a light emitting device arranged below the baseplate, configured to selectively illuminate the plurality of coupling knobs;
a position detection scanner with:
a light emitter configured for illuminating a grid of light beams extending in proximity to the plurality of coupling knobs, and
a light receiver configured to sense the presence or interruption of light emitted from the light emitter; and
a controller configured to receive a signal from the position detection scanner and to control the light emitting device arranged below the baseplate depending on the signal received from the position detection scanner.

13. An interactive building plate comprising:
a baseplate having an upper surface area provided with a plurality of coupling knobs adapted for mounting toy building blocks, the baseplate being made from a translucent or transparent material and comprising a user interface with a plurality of touch fields;
a light emitting device arranged below the baseplate, the light emitting device comprising a plurality of light emitting diodes (LEDs), each LED being independently controllable to emit light, wherein a number and mutual distance of the LEDs correspond to a number and mutual distance of the coupling knobs on the baseplate;
a position detection scanner comprising a frame extending along a periphery of the baseplate, the frame having a plurality of light emitters and a plurality of light receivers arranged to form a grid of light beams extending above the coupling knobs on the baseplate, wherein the position detection scanner is configured to detect a position of any interruption of the light beams; and
a controller communicatively coupled to the light emitting device and the position detection scanner, said controller being configured to control the light emitting device to display an image by selectively turning on or off and switching a color of any of the LEDs in response to a detected interruption of the light beams extending over a selected coupling knob or a selected touch field on the baseplate.

14. The interactive building plate according to claim 13, wherein the interruption of the light beams is provided by mounting one or more building blocks on the coupling knobs.

15. The interactive building plate according to claim 13, wherein the controller is further adapted to allow a user to program the controller via the user interface by touching the touch fields.

16. The interactive building plate according to claim 13, wherein the baseplate is made from a translucent or transparent plastic material.
